(19) United States
(12) Patent Application Publication
(10) Pub. No.: US 2001/0003563 A1
(43) Pub. Date: Jun. 14, 2001

(54) CONTINUOUS FLOW PASTE APPLICATOR FOR DRY WALL

(76) Inventors: DARYL G. SCHAUER, ANNANDALE, MN (US); ROBERT W. SEVERSON, ANDOVER, MN (US)

Correspondence Address: MOORE AND HANSEN, 3000 NORWEST CENTER, 90 SOUTH SEVENTH STREET, MINNEAPOLIS, MN, 55402

(21) Appl. No.: 09/204,012

(22) Filed: Dec. 1, 1998

(51) Int. Cl. B43K 5/02; B43K 7/10; B05C 11/10; B43K 5/18; A46B 11/00

(52) U.S. Cl. 401/5; 401/265; 401/266

(57) ABSTRACT

An apparatus for the application of drywall compound onto a taped drywall joint. The applicator uses an electrically powered, positive displacement pump which supplies a continuous flow of compound from a hopper to the applicator head via a fluid path. Remote controls on the handle of the applicator allow the operator to turn the pump on or off and also to select the optimal pump speed. The hopper is large enough so that an operator can apply compound to a number of joints before having to stop and refill the apparatus with compound.

### BACKGROUND OF THE INVENTION

This invention relates generally to a step in the construction of interior walls. After the wall of a building has been constructed, it is common to cover the wooden members or “studs” with dry wall (also known as sheet rock or wallboard). After the dry wall is in place, the joints formed where two pieces of drywall abut are typically filled in before the wall is painted or wall papered. Failure to do so results in visible discontinuities in the finished wall. Filling in these joints is usually a four step process.

The first step involves applying a layer of thick paste called mastic or joint compound. Once the joint compound is applied, and while it is still wet, tape is applied over the wet mastic and pressed into the joint. This taping step is the second step but is often combined with the first step through the use of a taping tool.

Numerous taping tools have been developed which apply a layer of compound to one side of tape supplied from a roll and press the tape and compound into the joint. This is accomplished in one sweeping motion of the taping tool. Prior art taping tools will be discussed in more detail below.

The third step is to apply a second layer of compound over the tape. This compound acts to blend the tape into the wall by covering the edges of the tape and any remaining groove in the joint. Though some of the prior art applicators try to combine this step with the first two, it has been found that allowing the first layer of compound to dry thoroughly before applying the second is advantageous for several reasons. First, the compound shrinks as it dries. Allowing the first layer to dry thoroughly permits completion of the shrinking process so that the resulting crevice can be filled in completely. Second, it is often desirable to use a thinner, finishing compound for the second layer. Having an applicator with multiple supply hoppers with different compounds in each hopper either increases the weight of the tool, or decreases the supply of the compound. In either case the tool becomes more complicated and cumbersome.

The fourth step is optional but widely practiced. A third, wider layer of compound is applied over the second layer after the second layer has dried thoroughly and been sanded. This third layer is thinner than the second and is feathered into the walls resulting in an even finish which makes the abutment of the two wall boards virtually invisible when painted or papered. Because the second layer of compound is the thickest, it is common to allow the second layer to dry for at least one day, more often two days, before the third layer is applied.

The four steps just described were originally performed by hand and were all time consuming and labor intensive. This led to numerous developments in the art to reduce the time and effort required to finish walls. Despite these efforts, little progress has been made.

U.S. Pat. No. 3,116,195 to Lathrop et. al. issued Dec. 31, 1963 generally relates to an applicator which applies tape coated on one side with compound to a joint. The applicator receives the compound from a supply hopper by means of an internal combustion engine powering a positive displacement pump. Despite the obvious carbon monoxide gas dangers associated with operating a gasoline engine indoors, the positive displacement pump relies on a relief valve to open in order to divert extra compound back into the supply hopper via a bypass line if excess pressures develop. As positive displacement pumps have the capacity to generate tremendous pressures, it is unwise to rely on a mechanical valve, which is in constant contact with a thick cement-like paste, to open in order to prevent casualties.

U.S. Pat. No. 4,080,240 issued Mar. 21, 1978 to Dysart, relates to a similar taping tool with a different pump. Dysart relates to a pneumatic pump having two tanks containing compound and floating pistons resting on the surface of the compound. A compressor supplies high pressure air to the top of the tanks, above the pistons. This places downward pressure on the pistons and pushes the compound through a supply line to the applicator. Though this may appear to be safer than using an internal combustion engine indoors, there are possible dangers associated with high pressure air. For instance, in order to refill the containers, the pistons usually have to be removed. As it is generally difficult to remove a sealed piston from a cylinder, Dysart uses a high pressure line from the compressor to the bottom of the cylinders. Valves are used to align the high pressure air through these lines in order to blow the cylinders to the top of the tanks for easier removal. There are obvious potential dangers inherent in this system. Not only is valve alignment crucial to operation in either mode, it is dangerous to use high pressure air to deliver a potential projectile to an operator.

A popular system used today is a commercially available taping tool known as a “Bazooka”. Variations of this tool are available from a number of manufacturers. These tools use a hollow, telescoping, cylindrical handle with an actuator and a piston. The handle is filled with compound and the operator pushes on the actuator section of the handle to push the compound to the head of the tool where the taping mechanism is affixed. The taping mechanism receives the compound and applies it to the wall-side of the tape as the tape is being applied to the joint.

A tool known as a “finish box” is commonly used to apply the second and third layers of compound after the first has dried. A similar cylindrical handle with a piston is used in conjunction with a box-type head. The compound in the handle is either pushed through the cylinder manually or is forced through by compressed air pushing on a piston. The compound is delivered to a hollow, box-shaped head. The back wall of the head is attached such that it can slide into the head like a rectangular piston. This wall is also attached to the handle so that the operator can apply force to the sliding wall by pushing on the handle. The opposing wall of the head has a slot through which a layer of the compounded passes and a scraper blade trailing the slot which applies the compound to the wall with uniform thickness. In operation, the piston in the handle presses on the compound stored in the handle, thereby keeping the box head full of compound. The operator, pushing on the handle puts pressure on the rear, piston-like wall of the box, squeezing the compound through the slot which is then smoothly applied to the wall as it passes under the blade.

Though this method of application is effective, it is laborious and time-consuming. The operator must maintain considerable force on the handle to keep a steady flow of compound exiting the box. Furthermore, having the supply of compound stored in the handle of the tool makes the tool heavy. Finally, the supply of compound in the handle is only enough to apply compound to two or three joints. Once the handle is empty, the operator has to refill the tool by pumping compound into the handle. The amount of time the operator spends refilling the applicator can become significant.

There have been few attempts at improving the steps of the drywall process which occur after the first layer of compound and tape have been applied. Most attempts have tried to combine all of the steps into one applicator. An example is U.S. Pat. No. 5,545,287 issued Aug. 13, 1996 to Carlson, which relates generally to a device to be attached to a Bazooka that redirects the excess compound, which gets squeezed out the sides of the tape, onto the outside surface of the tape to fill in the remaining crack.

Another example is U.S. Pat. No. 5,013,389 issued May 7, 1991 to Retti which relates generally to a device that attempts to accomplish all steps at once. The device uses multiple compound supply lines from a backpack tank worn by the operator to apply the various coats of the compound to either side of the tape. In order to overcome the problems with drying, Retti suggests a formula for a quick drying compound to be used. However, even a quick drying compound generally cannot dry within the fraction of a second between its application and the application of the next layer.

These and other attempts to combine all of the above steps into one typically fail for lack of sufficient drying time. This is evidenced by the standard practice in the industry of waiting at least one day between applications. Two days are preferred in humid climates. Additionally, these tools require that the same compound consistency be used for all of the applied layers.

There is a need for a tool which is designed to apply compound of any desired consistency to the outer side of tape, which has already been applied to a joint using a Bazooka or similar device, and has an ample supply of compound which is delivered from a hopper to the wall without requiring excessive lifting, pushing, or other physical exertion by the operator.

### BRIEF SUMMARY OF THE INVENTION

Advantageously, this invention generally provides a tool for applying compound over a layer of compound and tape which has already been applied to a wallboard joint and allowed to dry.

It is another characteristic of this invention to provide a tool light enough for applying wallboard compound without substantially tiring the operator.

This invention is also beneficial in that it provides a tool for applying wallboard compound which generally does not require excess physical exertion by the operator in order to exude the compound from the tool.

It is another advantage that the invention generally provides a tool for applying wallboard compound which receives a substantially continuous supply of compound from a hopper with an electrically-powered pump.

It is also a characteristic that the invention provides a system for applying wallboard compound which is generally safe to operate under normal operating conditions and practices.

The instant invention comprises an applicator for drywall compound having a hopper with a supply of compound which is pumped to an applicator head designed to allow application of the compound without requiring the operator to exert force on the tool to dispense the compound. The tool can be broadly described as having three parts: a pump, a handle, and an applicator head.

The pump is preferably an electric, positive-displacement rotor/stator pump such as those commercially available from PETE'S Equipment of Auburn, Wash., which are able to pump thick compounds. These pumps are designed for pumping coating compound to a dual supply spray nozzle which also receives compressed air. The compressed air mixes with the compound and blasts it onto the receiving surface. However, these pumps have been modified for use with the present invention by not attaching a spray nozzle with a compressed air line.

The handle comprises a tube of sufficient diameter to concentrically house or form a section of the compound supply line and allow for a comfortable grip by the operator, preferably between ½and 2 inches, more preferably on the order of ¾to 1 inch in diameter. Additionally, the handle preferably includes an on/off switch and a flow regulator knob for remote control of the pumping speed.

The on/off switch is preferably a button switch which is normally off such that whenever the operator releases the button, the pump shuts off. The switch may be electrically connected to the control box of the pump motor but is preferably a remote control switch.

The flow regulator knob is preferably an analog dial knob which controls a variable resistor in the pump motor circuit such that any of a continuous range of pumping speeds may be selected. Like the on/off switch, the regulator knob may be electrically connected to the control box of the pump motor but is preferably a remote control knob.

The applicator head comprises a thin, hollow box of a rigid material, preferably brushed aluminum, with a ball joint connecting the rear face of the box with the handle. The ball joint preferably has a passage extending through it to allow passage of the compound into the box. More preferably, the ball joint has a quick release mechanism to allow a variety of applicators to be attached to the handle for applications such as corners and the like.

The front face of the applicator has a leading edge and a trailing edge. The leading edge has rollers to allow the applicator to easily slide along the wall during application. The rollers also space the leading edge away from the wall to allow room for the compound to exit the applicator.

The compound is applied through a thin, slot-like exit opening proximate the trailing edge and extending substantially the width of the box. As the compound contacts the wall, it must pass under a blade which runs along and defines the trailing edge of the applicator. The blade presses the compound to the wall and leaves a smooth, flat surface on the resulting layer of compound.

### BRIEF DESCRIPTION OF THE DRAWINGS

FIG. 1 is a perspective view of the present invention being used by an operator wherein the pumping system is shown as an elevational view which is not to scale and has a cutaway of the pump; and,

FIG. 2 is a side elevational view taken generally along lines 2-2 of FIG. 1.

### DESCRIPTION OF THE PREFERRED EMBODIMENTS

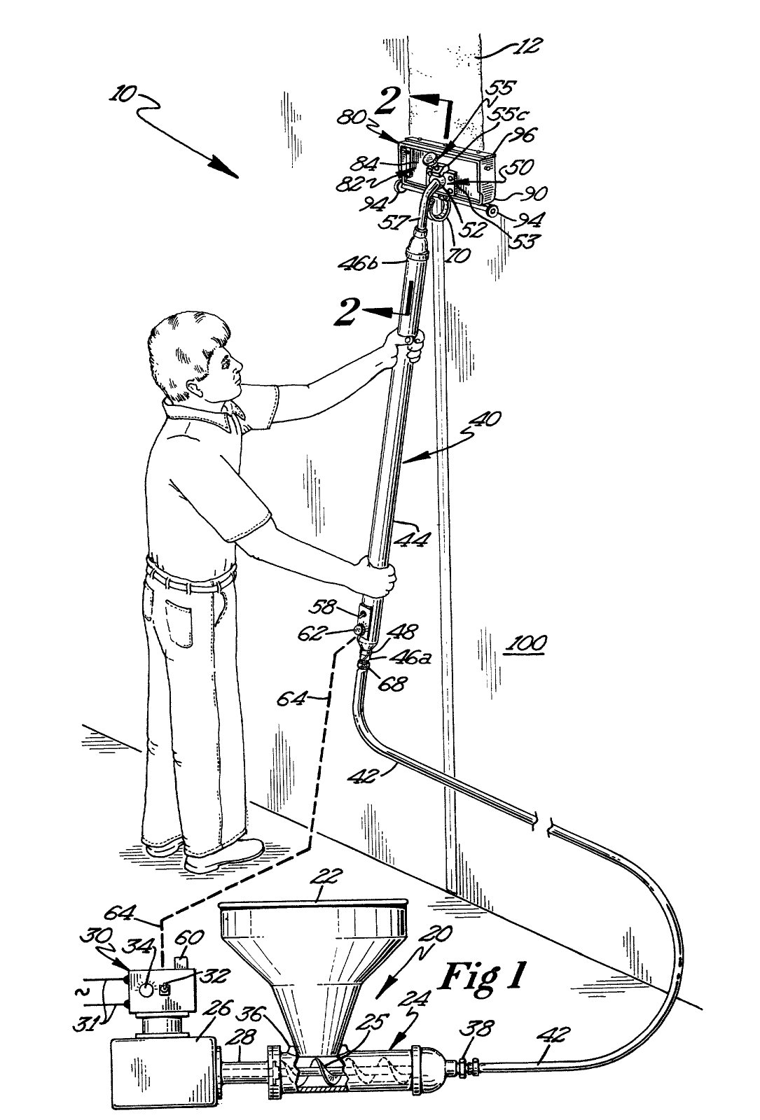

With reference to the drawings, and first to FIG. 1, there is shown a tool 10 made up of a pump system 20, a handle 40, and an applicator head 80. All three components of tool 10 are in fluid connection with each other so that drywall compound 12 communicates between the compound supply hopper 22 of pump 20 and head 80.

Pump system 20 is a commercially available pump system, preferably of the type manufactured by PETE'S Equipment of Auburn, Wash. The pump system 20 comprises a hopper 22, a positive displacement pump 24, and an electric motor 26 operably connected to pump 24 via a drive shaft 28. A control panel 30 provides a circuit 31 feeding electricity to pump motor 26 and has an on/off switch 32, and a pump speed selector 34. Pump 24 has an inlet 36 and an outlet 38. Inlet 36 is fluidly connected to hopper 22, which could be provided in various sizes. Positive displacement of the compound 12 from hopper 22 through pump 24 to its outlet 38 is accomplished by rotary pump auger 25 connected to motor drive shaft 28. The rotary action of auger 25 ensures an even, continuous flow of compound 12 to applicator head 80.

Handle 40 generally comprises a supply line 42 and a hollow housing 44 with ends 46a and 46b. Supply line 42 is fluidly connected to outlet 38 of pump 24 and delivers compound to applicator head 80. Supply line 42 runs through, and is supported by, elongated, hollow housing 44, which attaches to applicator head 80 via a ball and socket joint 50.

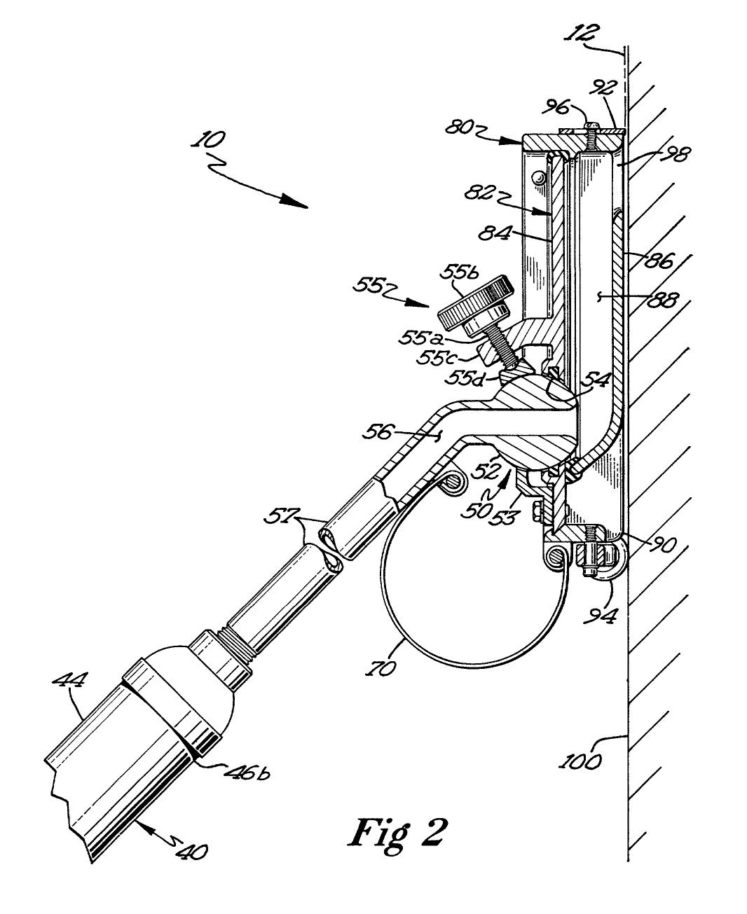

In a preferred embodiment, supply line 42 comprises a continuous flexible hose, preferably rubber, more preferably braided plastic or nylon, which attaches to outlet 38 of pump 24. Line 42 enters housing 44 at its end 46a and runs through housing 44 and attaches to a fluid passage 56, shown in FIG. 2, which extends through ball and socket joint 50 and is defined by a neck 57. A collar 48 attached to end 46a tightly surrounds supply line 42, holding it in place.

In a more preferred embodiment, (not shown in the Figures), a tube extends through housing 44 and is attached to fluid passage 56 of ball 52 of ball and socket joint 50. The tube is also attached to collar 48. Supply line 42 therefore runs from outlet 38 of pump 24 to end 46a of housing 44 where it attaches to the tube. Preferably, supply line 42 attaches to the tube via swivel coupling 68 in order to prevent supply line 42 from becoming twisted during use.

In an even more preferred embodiment, shown in FIG. 2, hollow housing 44 is attached at end 46a to supply line 42 via swivel coupling 68 in such a way as to form part of the fluid path from the hopper 22 to the applicator head 80. In this embodiment, hollow housing 44 fills with compound and directs the compound from the supply line 42 to neck 57 which is threadably connected to end 46b of handle 40.

In yet another embodiment (not shown in the Figures), supply line 42 comprises a continuous flexible hose which attaches to outlet 38 of pump 24. Line 42 enters housing 44 at its end 46a and runs partially through housing 44, exiting through an opening in housing 44 near end 46b and attaches to a fluid passage in rear face 84 of applicator head 80. In this embodiment, it is unnecessary for ball and socket joint 50 to have a fluid passage. Again, a collar 48 attached to end 46a tightly surrounds supply line 42, holding it in place. It is also envisioned that supply line 42 run directly to a fluid passage in rear face 84 of applicator head 80 without entering handle 40. In this embodiment, supply line 42 may or may not be attached to handle 40.

It is preferred that handle 40 have a remote on/off switch 58 which remotely opens and closes circuit 31 of control panel 30. Though it is envisioned that this remote switch 58 be electrically connected to control panel 30 via a wire that runs along supply line 42, it is preferred that remote on/off switch 58 be an infrared transmitter which is operably communicating with an infrared receiver 60 on control panel 30 and integrated into circuit 31. It is preferred that switch 58 be a normally off switch which requires an operator to keep the switch depressed in order to close circuit 31.

Similarly, it is preferred that handle 40 have a remote pump speed selector 62, proximate switch 58, which remotely controls the speed of pump motor 26 thereby allowing the operator to adjust the flow rate of compound 12 while the operator is using tool 10. Again, it is preferred that remote pump speed selector 62 be an infrared transmitter which is operably communicating with receiver 60 to adjust the speed of motor 26. However, it is also envisioned that selector 62 be electrically connected to circuit 31 via a wire running along supply line 42.

Applicator head 80 is essentially a thin, hollow box 82 of a rigid material, preferably aluminum, with a front face 86 and a rear face 84. Inside box 82 is a reservoir 88 partially defined by front face 86 and rear face 84. Socket 54 of ball and socket joint 50 is defined by rear face 84 of box 82 and is further defined by a support plate 53. It is preferred that socket 54 have a quick release mechanism 55 such that head 80 can be quickly and easily removed from handle 40 for cleaning and so that differently shaped heads may be interchanged with head 80 for various applications such as applying compound to comers and tight places. Mechanism 55 may comprise a threaded shaft 55a having a rotary operating handle 55b at its outer end and received within a threaded sleeve 55c. Tightening threaded shaft within sleeve 55c by rotation of handle 55b engages the tip of shaft 55c within a mating seat 55d on ball support plate 53 to secure ball 52 to head 80.

Applicator head 80 is given stability relative to handle 40 with a biasing mechanism, preferably a band spring 70. Band spring 70 is more preferably a curved, flat, enlongated metal band attached at one end to the handle and attached at the other end to the applicator head. Band spring 70 acts to substantially return head 80 to a normal position after head 80 is rotated around ball and socket joint 50.

Front face 86 of applicator 80 has a leading edge 90 and a trailing edge 92. Leading edge 90 preferably has rollers 94 rotatably attached to box 82 and extending outwardly therefrom to allow applicator 80 to easily slide along a wall during application. Rollers 94 also act to space leading edge 90 away from wall 100 to allow room for compound 12 to exit applicator 80.

Trailing edge 92 is defined by a blade 96 which protrudes outwardly and extends across front face 86. Front face 86 also defines a slot opening 98 leading into reservoir 88.

In operation, hopper 22 is filled with a drywall compound 12 of a desired consistency. The operator then ensures on/off switch 32 is turned on and picks up handle 40 of tool 10. The operator elevates applicator head 80 using handle 40 such that trailing edge 92 of head 80 is at the top of a joint to which compound 12 is to be applied.

The operator then depresses remote on/off switch 58 on handle 40. An infrared signal 64 is sent by switch 58 to infrared receiver 60 on control panel 30, closing circuit 31, thereby providing electricity to actuate motor 26.

Motor 26 rotates, turning pump auger 25 of pump 24 via drive shaft 28. Pump 24 draws compound 12 through inlet 36 and pushes compound 12 out outlet 38 and into supply line 42. Compound 12 follows supply line 42 to swivel coupling 68. Compound 12 travels through hollow housing 44 of handle 40 to ball and socket joint 50. Compound 12 is pumped through fluid passage 56 of joint 50 and into reservoir 88 of head 80. Pump 24 quickly fills reservoir 88 and compound 12 is pushed through slot opening 98 of front face 86, thereby contacting wall 100.

The operator then runs applicator 80 down wall 100 such that compound 12 passes under and is spread evenly by blade 96 against wall 100. At this point the operator may want to adjust the amount of compound 12 being applied to wall 100. To do so, the operator adjusts remote pump speed selector 62 which sends an infrared signal 64 to infrared receiver 60 which increases or decreases the voltage to motor 26 through a known device, such as a variable resistor, in circuit 31.

The present invention having thus been described, other modifications, alterations or substitutions may present themselves to those skilled in the art, all of which are within the spirit and scope of the present invention. It is therefore intended that the present invention be limited in scope only by the claims attached below.

What is claimed is:

1. A tool for applying drywall compound comprising:
a compound supply hopper;
an electrically driven pump with an inlet and an outlet;
a handle with a first end and a second end;
an applicator head operably connected to the second end of the handle, said head being constructed and arranged to dispense compound into a taped wall joint; and
a fluid path extending from the hopper to the applicator head and fluidly connecting the hopper, the pump, and the applicator head.

2. The tool of claim 1 wherein the fluid path comprises:
a fluid connection between the hopper and the inlet of the pump; and
a supply line with two ends, one end fluidly connected to the outlet of the pump, the other end fluidly connected to the applicator head.

3. The tool of claim 1 wherein the fluid path comprises:
a fluid connection between the hopper and the inlet of the pump;
a supply line with two ends, one end fluidly connected to the outlet of the pump, the other end fluidly connected to the first end of the handle; and
a fluid passage extending through the handle and into the applicator head for delivery of compound to the applicator head.

4. The tool of claim 3 wherein the other end of the supply line is connected to the first end of the handle with a swivel coupling.

5. The tool of claim 1 wherein the second end of the handle is operably connected to the applicator head with a ball and socket joint.

6. The tool of claim 5 wherein the ball and socket joint further comprises a quick release mechanism for release and separation of the applicator head from the handle.

7. The tool of claim 1 wherein the electrically driven pump further comprises an electric motor with a control panel, the control panel having controls that allow electricity to flow to the motor and vary the speed of the motor.

8. The tool of claim 7 wherein the handle further comprises a remote on/off switch and a remote motor speed control knob mounted thereon and in remote communication with the control panel of the electric motor.

9. The tool of claim 1 wherein the applicator head further comprises:
a front face;
a rear face operably connected to the second end of the handle;
a compound reservoir partially defined by the front face and the rear face and being in fluid communication with the fluid path;
the front face having a leading edge, a trailing edge, a blade, and an exit opening, the exit opening being defined by the front face proximate the trailing edge and extending into the reservoir, the blade protruding outwardly from the front face and defining the trailing edge.

10. The tool of claim 1 wherein the pump comprises a rotary auger in fluid flow communication with the hopper and a motor having a drive shaft operably connected to the auger.

11. A tool for applying drywall compound comprising:
a compound supply hopper;
an electrically driven pump with an inlet and an outlet, the inlet fluidly connected to the hopper;
a compound supply line with two ends, one end being fluidly connected to the outlet of the pump;
a handle having a first end and a second end; and
an applicator with a front face, a rear face, a compound reservoir partially defined by the front face and the rear face, the front face having a leading edge, a trailing edge, a blade, and an exit opening, the rear face being operably connected to the second end of the handle, the reservoir being fluidly connected to the other end of the supply line, the exit opening extending through the front face proximate the trailing edge, the blade protruding outwardly from the front face, extending across the front face and defining the trailing edge.

12. The tool of claim 11 wherein the pump further comprises a positive displacement pump.

13. The tool of claim 12 wherein the pump comprises a rotary auger in fluid flow communication with the hopper.

14. The tool of claim 11 wherein the pump further comprises an electric motor having a control panel, the control panel having an on/off switch electrically connected to the motor and also having a motor speed knob electrically connected to the motor.

15. The tool of claim 11 wherein the handle is operably connected to the rear face of the applicator by means of a ball and socket joint.

16. The tool of claim 15 wherein the fluid passage of the handle extends through the ball and socket joint.

17. The tool of claim 14 wherein the handle further comprises a remote on/off switch and a remote motor speed control knob mounted thereon and in remote communication with the control panel of the electric motor.

18. The tool of claim 17 wherein the remote on/off switch is a normally off switch which must be depressed in order to allow power to be supplied to the motor.

19. The tool of claim 11 wherein the supply line is fluidly connected to the first end of the handle with a swivel coupling.

20. A tool for applying drywall compound comprising:
a pump having an electric motor, a positive displacement pumping mechanism operably connected to the motor and having an inlet and an outlet, a control panel electrically connected to the motor for controlling the motor, and a hopper fluidly connected to the inlet of the pumping mechanism;
a handle having a compound supply tube with two ends, a ball joint with an internal fluid passage extending therethrough, and a housing with two opposite ends, the supply tube fluidly connected to the outlet of the pumping mechanism at one end and fluidly connected to the internal fluid passage of the ball joint at the other end and extending through the hollow housing and attached to the housing at both ends of the housing, the housing having mounted thereon a remote power switch remotely and operably connected to the control panel for controlling the electric motor; and,
an applicator operably attached to the handle and having a front face, a rear face, a compound reservoir partially defined by the front face and the rear face, a leading edge, a trailing edge, rollers, a blade, an exit opening and a ball joint receiving socket attached to the rear face and having a fluid passage extending therethrough and leading into the reservoir, the exit opening extending through the front face proximate the trailing edge, the blade protruding outwardly from the front face, extending across the front face and defining the trailing edge, the ball joint receiving socket operably, rotatably and removably connected to the ball joint of the handle, the fluid passage of the ball joint and the fluid passage of the socket aligning to allow fluid to communicate between the supply line and the reservoir, the rollers operably attached to leading edge of the applicator.

21. The tool of claim 20 wherein the remote power switch further comprises a wire remotely and operably connecting the switch to the control panel.

22. The tool of claim 20 wherein the remote power switch further comprises an infrared transmitter and the control panel further comprises an infrared receiver, the transmitter and receiver remotely and operably connecting the switch to the control panel.

23. The tool of claim 20 wherein the handle further comprises a pump speed dial mounted thereon and remotely and operably connected to the control panel of the electric motor.
